(19) United States
(12) Patent Application Publication
(10) Pub. No.: US 2006/0023598 A1
(43) Pub. Date: Feb. 2, 2006

(54) Method and apparatus for protecting against copying of content recorded on optical recording media

(76) Inventors: James P. Babinski, Throop, PA (US); James J. Musto, Pittston, PA (US); Dominick A. Dallaverde, Pittston Township, PA (US)

Correspondence Address: COOPER & DUNHAM, LLP, 1185 AVENUE OF THE AMERICAS, NEW YORK, NY, 10036, US

(21) Appl. No.: 10/903,099

(22) Filed: Jul. 30, 2004

(51) Int. Cl. G11B 19/04; G11B 5/09

(52) U.S. Cl. 369/53.21; 369/47.12

(57) ABSTRACT

Methods and apparatuses for protecting against copying of content recorded on optical recording media are provided. An area of an optical recording medium is designated to be ignored by a standards-compliant optical media player reproducing content recorded on the optical recording medium. Unreadable data is written to the designated area which is ignored by the standard-compliant optical media player. When an optical medium drive attempts to read the unreadable data in order to perform a one-to-one copy process on data recorded on the recording medium, the optical medium drive is unable to complete the one-to-one copy process.

### TECHNICAL FIELD

This application relates to copy protection for optical recording media. In particular, the application relates to techniques for preventing copying of content recorded on optical recording media.

### DESCRIPTION OF RELATED ART

Use of digital media for storing and transporting content has proliferated in recent years.

For example, optical storage media (“optical media”), such as CDs (compact discs) and DVDs (digital versatile discs or digital video discs), have popularly been used for storing and transporting digital content. For example, multimedia content and/or other data can be stored on optical media in an optically readable manner.

Several formats of optical media are currently available, including the following: (i) read-only formats such as CD-DA (digital audio compact disc), CD-ROM (CD-read-only memory), DVD-ROM, etc.; (ii) write-once read-many times formats such as CD-R (CD-recordable), and DVD-R (DVD-recordable), etc.; (iii) rewritable formats such as CD-RW (CD-rewriteable), DVD-RAM (DVD-Random Access Media), DVD−RW or DVD+RW (DVD-rewriteable), PD (Phase change Dual disk) and other phase change optical discs; and (iv) hybrid optical media which include a combination of formats, such as CD-PROM (CD programmable ROM) which combines read-only CD-ROM format with recordable CD-R format.

In conventional read-only type optical media (e.g, CD-ROM, DVD-ROM), data is generally stored as a series of “pits” embossed with a plane of “lands”. Microscopic pits formed in the surface of the plastic medium are arranged in tracks, conventionally spaced radially from the center hub in a spiral track originating at the medium center hub and ending toward the medium's outer rim. The intensity of the light reflected from a read-only medium's surface by an optical medium player or reader varies according to the presence or absence of pits along the information track. When the readout spot is over the flat part of the track, more light is reflected directly from the disc than when the readout spot is over a pit. A photodetector and other electronics inside the optical medium player translate the signal from the transition points between these pits and lands caused by this variation into the 0s and 1s of the digital code representing the stored information.

Optical media can be used to store and distribute large volumes of content. For example, a CD-ROM typically has a capacity in excess of 600 MB. Conventional DVD read-only discs have a capacity of from 4.7 GB to 17.0 GB. Conventional CD-ROMs have a minimum pit length of 0.834 μm, a pit width of 0.6 μm and a track pitch of 1.6 μm. Conventional DVD-ROMs, in comparison, typically have a minimum pit length in a range of 0.4 to 0.44 μm, a pit width of 0.32 μm and a track pitch of 0.74 μm. The reduced dimensions of DVDs (relative to CDs) allow them to have higher density than CDs.

Other optical media have recording densities significantly greater than that of a CD. For example, conventional write-once DVDs have a capacity of 3.95 GB to 7.90 GB, and conventional rewriteable DVDs have a capacity of from 2.6 GB to 10.4 GB. In contrast, a conventional magnetic floppy diskette is only capable of storing 1.44 Mb of data. The high storage density of optical media has allowed optical media generally to replace magnetic media, for storing multimedia content and/or data.

Unfortunately, the high capacity of optical media, coupled with recent enhancements to personal computers and the advent of recordable optical media technology, also renders optical media popular for illicit use. For example, unauthorized copying of proprietary and/or copyrighted, recorded content from optical media to optical media on a large scale (also referred to as “piracy”) is a growing concern. The piracy typically entails using software on a computer system having an optical medium drive to copy content from a recorded optical medium onto recordable media such as CD-R or CD-RW (or DVD−R, DVD−RW or DVD+RW) discs.

The term “optical medium drive” as used in this application refers to the component in a computer system which, coupled with device driver software and other interface software, allows data recorded on an optical medium to be accessed by the computer system (typically, the component in this context is known in the art as a “ROM drive”). Some computer systems are also equipped to write data onto a recordable or rewritable optical medium. “Optical medium drive” as used in this application also encompasses drives which include means for writing data onto a recordable or rewritable optical medium.

The term “optical media player” as used in this application refers to an appliance or software which can be used to reproduce content from an optical medium. An optical media player is also sometimes referred to as a “reader”.

Software used for piracy of recorded content typically performs a one-to-one data copy process on a computer system in order to ensure that all of the data is copied from the recorded medium onto another medium. Generally, the data copy process includes reading the data on the recorded optical medium with an optical medium drive of the computer system, storing the data on a hard disk of the computer system, and then recording the data onto recordable optical media (as many as desired).

Several copy protection techniques and devices have been proposed to limit copying of content on optical media.

One proposed copy protection method (known as Analog CPS or Macrovision) requires the installation of circuitry in every optical media player used to read optical media. When an optical medium is “Macrovision Protected,” the electronic circuit reproducing data from the medium sends a colorburst signal to the composite video and s-video outputs of the player, resulting in imperfect copies when the copies are made based on a video signal supplied through the composite video and s-video outputs. The use of Macrovision also, however, adversely affects normal playback quality.

According to another technique, the optical medium contains recorded content and, in addition, information which dictates whether the recorded content can be copied. For example, according to the Copy Generation Management System (CGMS), each disk carries a code that authorizes or forbids copying of the recorded content. A disk with a code authorizing copying can be copied, but the copying device changes the code so that further copies are not possible. However, the CGMS technique suffers the disadvantages that large numbers of copies can be made of content on a disk, when the disk bears the code authorizing a single copy, by reading the recorded content with an optical medium drive, storing the data on a hard disk, and then recording the data on as many media as desired. Further, the copy prevention mechanism can be circumvented even when the access code indicates that no copies are permitted, if the entire data content of the disk bearing the code authorizing copying is copied. Therefore, in order for copy restriction information to be effective, the device that is used to copy the media must be equipped to recognize the copy restriction information and also must respect the information to reject unauthorized copying.

In another proposed technique, data stored on the optical medium is encrypted using a particular algorithm (for example, CSS in the case of DVD) that is designed to prevent direct, digital-to-digital copying. The CSS algorithm compresses the data files on a sector-by-sector basis and then scrambles them. Each CSS-compliant player which is authorized to reproduce the encrypted data is provided with one of a large number of keys that allow the player to decode/descramble the data on the media, but is prevented from distributing copies of the keys needed to decrypt the data. However, complementary decryption tools generally can readily be developed by those with knowledge of the encryption algorithm. For example, the CSS encryption algorithm has been broken and has been disseminated over the Internet.

Another technique includes writing a copy protection code at a pre-determined location on the disk during its fabrication. Media players are made to reject disks that do not have the protection code in the right location. However, a device designed or adapted to read all data at all locations on the disk can copy the disk including its protection code, and the illegal copy thus-obtained is then strictly identical to the original.

Other techniques which involve the use of a specific “signature” on the disk can consist in a variation of certain recording parameters, such as the form of the marks (depth, width, length), introduction of an asymmetry in the marks, wobbulation of the track at special frequencies, and so on. These variations constitute the signature that must be sought by the media player, and they cannot be reproduced by ordinary CD writers such as CD-R recorders. However, standard media players generally are not adapted to detect these variations.

There remains a need for improved techniques for protecting against unauthorized copying of content on optical media which does not depend on encryption codes or adapted (or special) hardware. Such techniques should allow the optical media to be readable by the large number of existing standards-compliant optical media players, without requiring modifications to the standards-compliant players.

### SUMMARY

This application describes method and apparatus for protecting against copying of content recorded on optical recording media. In one embodiment, a method for protecting against copying of content recorded on optical recording media, includes designating an area of an optical recording medium to be ignored by a standards-compliant optical media player reproducing content recorded on the optical recording medium, and writing unreadable data to the designated area which is ignored by the standard-compliant optical media player. When an optical medium drive attempts to read the unreadable data in order to perform a one-to-one copy process on data recorded on the recording medium, the optical medium drive is unable to complete the one-to-one copy process.

An apparatus, according to one embodiment, for protecting against copying of content recorded on optical recording media includes means for designating an area of an optical recording medium to be ignored by a standards-compliant optical media player reproducing content recorded on the optical recording medium, and means for writing unreadable data to the designated area which is ignored by the standard-compliant optical media player. When an optical medium drive attempts to read the unreadable data in order to perform a one-to-one copy process on data recorded on the recording medium, the optical medium drive is unable to complete the one-to-one copy process.

The methods and apparatuses of this disclosure may be embodied in one or more computer programs stored on a computer readable medium or program storage device and/or transmitted via a computer network or other transmission medium. For example, a computer storage medium including computer executable code for protecting against copying of content recorded on optical recording media, according to an embodiment of the present disclosure, includes code for designating an area of an optical recording medium to be ignored by a standards-compliant optical media player reproducing content recorded on the optical recording medium, and code for writing unreadable data to the designated area which is ignored by the standard-compliant optical media player, wherein when an optical medium drive attempts to read the unreadable data in order to perform a one-to-one copy process on data recorded on the recording medium, the optical medium drive is unable to complete the one-to-one copy process.

This application also describes an optical recording medium including unreadable data written in an area which is designated to be ignored by a standard-compliant optical media player, and wherein when an optical medium drive attempts to read the unreadable data in order to perform a one-to-one copy process on data recorded on the recording medium, the optical medium drive is unable to complete the one-to-one copy process.

### BRIEF DESCRIPTION OF THE DRAWINGS

The features of the present application can be more readily understood from the following detailed description with reference to the accompanying drawings wherein:

FIG. 1 shows a flow chart of a process for protecting against copying of content recorded on optical recording media, in accordance with an embodiment of the present application;

FIG. 2 shows a flow chart of a portion of a DVD creation process including authoring and pre-mastering, according to one embodiment; and

FIG. 3 shows a schematic diagram of DVD authoring, including an apparatus for protecting against copying of content recorded on optical recording media, according to one embodiment.

### DETAILED DESCRIPTION

This application provides tools (in the form of methodologies, apparatuses, and systems) for protecting against copying of content recorded on optical recording media. The apparatus and method of the present disclosure may be implemented in the form of a software application (such as optical media authoring software), or a plug-in for such a software application, running on a computer system, for example, a mainframe, personal computer (PC), handheld computer, server, etc. The software application may be stored on computer readable media or program storage device locally accessible by the computer system, for example, floppy disk, compact disk, hard disk, etc., or may be remote from the computer system and accessible via a hard wired or wireless connection to a computer network (for example, a local area network, the Internet, etc.) or another transmission medium.

The tools of this disclosure target piracy using software-driven devices that attempt to make a one-to-one copy of data recorded on optical recording media. When an optical recording medium is inserted in an optical medium drive, such software attempts to read the entire disc in order to perform the copy process. The techniques of this disclosure include adding data to an area of the optical medium which is unreadable by the optical medium drive and thus one-to-one copying of the optical medium can be prevented. At the same time, the data is invisible to an optical media player and does not adversely affect reproduction of the recorded content on the optical recording medium by standards-compliant optical media players.

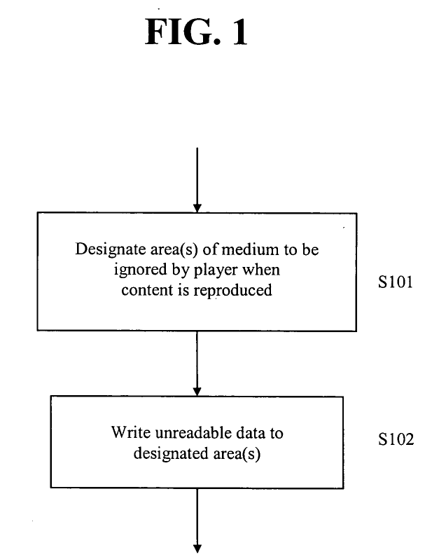

A method for protecting against copying of content recorded on optical recording media, according to one embodiment of the present application, will be described with reference to FIG. 1.

An area (for example, one or more data sectors) of an optical recording medium is designated to be ignored by a standards-compliant optical media player reproducing content recorded on the optical recording medium (step S101). Designation of the area to be ignored by the standards-compliant optical media player can be performed during an authoring process. The designation can signify that the designated area is free of normal content. The designation of the area to be ignored effectively indicates to the player that the designated area is to be skipped during playback of content from the optical recording medium.

The designation of the area to be ignored by the standards-compliant optical media player, in one exemplary embodiment, can be based on user input. According to another exemplary embodiment, the area designated to be ignored by the standards-compliant optical media player is predetermined. In any event, the designation of the area to be ignored by the standards-compliant optical media player is preferably compliant with optical media recording standards. As mentioned above, there are several optical media formats. Each optical media format is defined by a corresponding standard or specification. Each optical media standard or specification defines, amongst other requirements, the required format of data recorded on the corresponding type of optical media. The term “standards-compliant optical media player” refers to any optical media player which can reproduce content on an optical recording medium meeting the requirements of the standard or specification which governs that type of optical recording medium.

Unreadable data is written to the designated area which is ignored by the standard-compliant optical media player (step S102). The writing of unreadable data to the designated area can be performed during a pre-mastering process and/or a mastering process. The writing of unreadable data can include inserting corrupt data in the designated area or adding any data which renders the designated area unreadable, including, when applicable, leaving the designated area unformatted.

For example, the unreadable data may be a jump command added during the pre-mastering process. As another example, the unreadable data may be appropriately tagged in the file system (e.g., UDF, in the case of a DVD, or ISO 9660, in the case of some other media, discussed further below) during pre-mastering. The unreadable data may be a combination of bits which is prohibited by an optical media standard which governs the format of data on the optical recording medium.

Unreadable data may be added during mastering. For example, the unreadable data may be created during mastering by applying a stripe to the medium, or inserting extra pits or noncompliant pits (e.g., CD pits on a DVD), at a specified location.

When an optical medium drive attempts to read the unreadable data in order to perform a one-to-one copy process on data recorded on the recording medium, the optical medium drive is unable to complete the one-to-one copy process. For example, when the optical medium drive is unable to read the unreadable data for performing the one-to-one copy process, the optical medium drive may abort or shut down the one-to-one copy process. In another embodiment, when the optical medium drive is unable to read the unreadable data for performing the one-to-one copy process, the optical medium drive locks up. According to another embodiment, the optical medium drive can be a component of a computer system, and when the optical medium drive is unable to read the unreadable data for performing the one-to-one copy process, the optical medium drive crashes the computer system. In another exemplary embodiment, when the optical medium drive attempts to read the unreadable data, a warning screen is displayed.

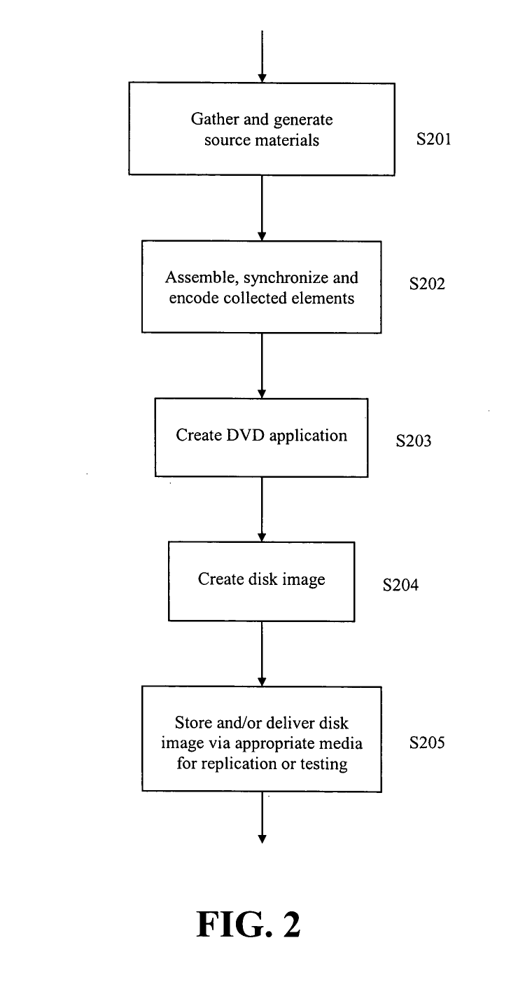

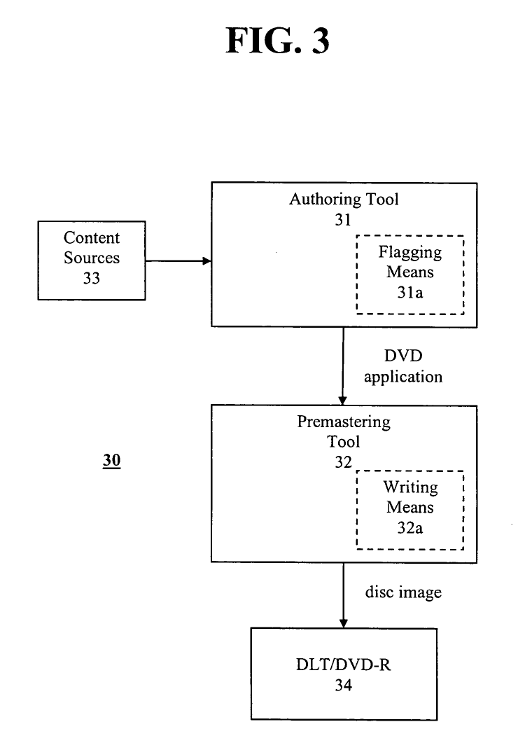

An overview of DVD creation will be provided below, with reference to FIGS. 2 and 3, in order to explain exemplarily how content can be recorded on an optical recording medium for which the tools of this application can be adapted to prevent copying.

Various types of content, including the following, can generally be recorded on a DVD: video to be played on a DVD-Video player; audio to be played on a DVD-Audio player; and computer software or data that can be accessed by a DVD-ROM drive. In addition, various combinations of content types may be recorded on a hybrid DVD. In order to preprocess the content into a suitable form for generating an appropriate disc image required for replication, DVD authoring and pre-mastering activities are performed.

DVD authoring is a process for developing a DVD application. Authoring includes gathering from content sources 33 (and creating) source materials including video assets, audio assets, menu content, still pictures, video stills, sub-pictures, and subtitle text, formulating information for video title set, video management, presentation control and data search, and determining and embedding functionality into the menus, sub-pictures, program chain information files, and video objects (step S201). All of these elements are assembled (into a content hierarchy or roadmap), synchronized, and encoded (step S202), and then a DVD application (that is, a self-contained and self-organized package of content which, when embodied on a DVD disc inserted in a DVD player, commences playing at the start of the package and then stops at the end, assuming no intervening user control) is created (step S203). An authoring tool 31 can be used to guide a user through the authoring process (step S201-S203), including flagging one or more area(s) on the medium to be ignored by the DVD player, and inserting data in specified locations (relative to content to be reproduced by a DVD player).

A DVD application comprises one or more title sets that contain the video and audio information as data streams. A title set can contain a number of menus and titles which are intended to act together. The menus collectively enable a viewer to navigate the DVD content, and thus deliver an interactive experience to the viewer. Thus, the data stored on the DVD includes presentation data (for example, video, still image, audio content, subtitles, captions, etc.) and navigation data (for example, information and commands that provide basic interactivity).

Each title set can be subdivided into chapters. Chapters in turn can be broken down into segments and/or scenes. Chapters, segments and scenes comprise plural cells which are the basic unit in the DVD application.

After a DVD application is completed, a pre-mastering tool 31 can be used to generate a disc image (step S204), and then store the disc image on appropriate media [such as Digital Linear Tape (DLT) or DVD−R 34] for replication or testing (step S205). More specifically, a Universal Disk Format (UDF) disc image is typically created that developers can use for testing or replicators can use for DVD manufacturing. Disc image files may also be tested through DVD player emulator software, in order to confirm that the data is in a format that can be read and decoded by DVD players. After pre-mastering, a replicator can take the DVD disc image source media and manufacture DVD disc replicas of that image.

The UDF specification (i.e. ISO/IEC 13346) is the basis for the DVD file system. UDF was defined as a file system standard for use across multiple computing platforms, and allows for provisions for the characteristics of the different major computer operating systems (for example, Macintosh, Windows, UNIX, etc.) so that the file system can appear to be native to any particular one of the platforms. UDF defines data structures such as volumes, files, blocks, sectors, CRCs (cyclical redundancy checks), paths, records, allocation tables, partitions, character sets and time stamps, and also provides methods for reading and writing information.

DVD-ROMs use a combination of the UDF and ISO-9660 formats called the UDF/ISO Bridge format. Because of the bridge with ISO-9660, DVD-ROM drives typically can read existing CD-ROM (Yellow Book) applications and are compatible with operating systems that utilize the ISO-9660 file structure.

DVD-Video discs require a modified UDF file system format due to the computing limitations of a basic DVD-Video player. A subset of the UDF standard that is implemented in DVD-Video players is called Micro-UDF. The constraints of Micro-UDF for DVD-Video are listed in Section 6.9.1 of the OSTA UDF Specification. DVD-Video players play discs that are mastered with the full UDF specification, but only recognize the defined aspects of Micro-UDF. Remaining information on a DVD disc that does not satisfy the Micro-UDF format would be ignored by the DVD-Video player. Thus, areas on the DVD disk which do not comply with the Micro-UDF format may be designated for writing unreadable data transparent to DVD players.

An apparatus for protecting against copying of content recorded on optical recording media, according to one exemplary embodiment, will now be explained with reference to FIG. 3. The apparatus comprises flagging means 31a for designating an area of an optical recording medium to be ignored by a standards-compliant optical media player reproducing content recorded on the optical recording medium, and writing means 32a for writing unreadable data to the designated area which is ignored by the standard-compliant optical media player. As shown in FIG. 3, the flagging means 31a can be included in an authoring tool, and the writing means 32a may be included in a pre-mastering tool. The flagging means may designate the area to be ignored in accordance with user input. In another embodiment, the area designated by the flagging means to be ignored is predetermined. Designation by the flagging means of the area to be ignored may signify that the designated area is free of normal content. Designation by the flagging means of the area to be ignored is preferably compliant with an optical media recording standard. In any event, when an optical medium drive attempts to read the unreadable data in order to perform a one-to-one copy process on data recorded on the recording medium, the optical medium drive is unable to complete the one-to-one copy process.

Authoring software is often used to guide a user through the authoring and pre-mastering processes, such that the output is compliant with all application standards (such as the various DVD specifications). Therefore, the term “authoring” often is used to denote a larger process which includes the authoring and pre-mastering subprocesses described above, for putting together content to be recorded on an optical recording medium. Authoring software is available commercially, as well as in the form of freeware or other open-source packages. For example, some authoring software tools and applications for Linux can be accessed through the following web pages:

http://www.gimp.org

http://mjpeg.sourceforge.net

http://toolame.sourceforge.net

http://mctoolame.sourceforge.net

http://ffmpeg.sourceforge.net

http://ac3.sourceforge.net

http://dvdauthor.sourceforge.net

http://www.dtek.chalmers.se/groups/dvd

http://www.xinehq.de

http://www.nongnu.org/dvdrtools

Mastering is a process, following pre-mastering in the DVD replication process, for creating a model, on a glass substrate, of the final DVD (which is used for generating a stamper, used as a mold for manufacturing the optical media). Mastering includes reading a disc image (information) from a source media, and then formatting, encoding, and processing the information into a modulated data signal. The modulated data signal is used to control the formation of the physical structures on the substrate.

Mastering is generally followed in the replication process by molding, metalizing, printing, and testing.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

For example, this application is also directed to an optical recording medium which include built-in protection against copying. Unreadable data is written in one or more areas of the optical recording medium which are designated to be ignored by a standard-compliant optical media player. When an optical medium drive attempts to read the unreadable data in order to perform a one-to-one copy process on data recorded on the recording medium, the optical medium drive is unable to complete the one-to-one copy process. The unreadable data, according to one exemplary embodiment, includes a combination of bits which is prohibited by an optical media standard which governs the format of data on the optical recording medium. A designated area to be ignored in most instances is free of normal content. The optical recording medium can be a DVD disc.

As another example, some software for performing one-to-one copying of content from an optical medium allows the user to deselect portions (such as programs, chapters, segments, scenes, cells, etc.) on the medium (for example, FBI logo/warning message). Thus, one may attempt to circumvent the techniques of this disclosure by deselecting portions which contain the unreadable data. However, the deselection will cause loss of content in the deselected programs, chapters, segments, scenes, cells, etc. Therefore, one approach to thwart content pirates who use such deselection software is to insert unreadable data in plural portions. Since the areas containing the unreadable data are designated to be ignored by media players, the presence of plural unreadable data is transparent to content playback by standards-compliant players.

In addition, it should be apparent to one skilled in the art that the copy prevention techniques described in this application can be integrated, and are preferably used together, with one or more other copy prevention schemes (such as Macrovision, CGMS, CSS, etc.).

The embodiments described herein are set forth to aid in an understanding of the subject matter of this disclosure through examples, but are not intended, and should not be construed, to limit in any way the claims of this application. Therefore, while specific terminology is employed for the sake of clarity in describing some exemplary embodiments, the present disclosure is not intended to be limited to the specific terminology so selected, and it is to be understood that each specific element includes all technical equivalents which operate in a similar manner.

What is claimed is:

1. A method for protecting against copying of content recorded on optical recording media, comprising:
designating an area of an optical recording medium to be ignored by a standards-compliant optical media player reproducing content recorded on the optical recording medium; and
writing unreadable data to the designated area which is ignored by the standard-compliant optical media player,
wherein when an optical medium drive attempts to read the unreadable data in order to perform a one-to-one copy process on data recorded on the recording medium, the optical medium drive is unable to complete the one-to-one copy process.

2. The method of claim 1, wherein the designation of the area to be ignored by the standards-compliant optical media player is performed during an authoring process.

3. The method of claim 1, wherein the designation of the area to be ignored by the standards-compliant optical media player signifies that the designated area is free of normal content.

4. The method of claim 1, wherein the designation of the area to be ignored by the standards-compliant optical media player is based on user input.

5. The method of claim 1, wherein the area designated to be ignored by the standards-compliant optical media player is predetermined.

6. The method of claim 1, wherein the designation of the area to be ignored by the standards-compliant optical media player is compliant with an optical media recording standard.

7. The method of claim 1, wherein the writing of unreadable data to the designated area which is ignored by the standard-compliant optical media player is performed during a pre-mastering process.

8. The method of claim 1, wherein the writing of unreadable data to the designated area which is ignored by the standard-compliant optical media player is performed during a mastering process.

9. The method of claim 1, wherein when the optical medium drive is unable to read the unreadable data for performing the one-to-one copy process, the optical medium drive aborts the one-to-one copy process.

10. The method of claim 1, wherein when the optical medium drive is unable to read the unreadable data for performing the one-to-one copy process, the optical medium drive locks up.

11. The method of claim 1, wherein the optical medium drive is a component of a computer system, and when the optical medium drive is unable to read the unreadable data for performing the one-to-one copy process, the optical medium drive crashes the computer system.

12. The method of claim 1, wherein when the optical medium drive attempts to read the unreadable data, a warning screen is displayed.

13. The method of claim 1, wherein the optical recording medium is a DVD disc.

14. A computer system, comprising:
a processor; and
a program storage device readable by the computer system, tangibly embodying a program of instructions executable by the processor to perform the method claimed in claim 1.

15. A program storage device readable by a machine, tangibly embodying a program of instructions executable by the machine to perform the method claimed in claim 1.

16. A computer data signal transmitted in one or more segments in a transmission medium which embodies instructions executable by a computer to perform the method claimed in claim 1.

17. An apparatus for protecting against copying of content recorded on optical recording media, comprising:
flagging means for designating an area of an optical recording medium to be ignored by a standards-compliant optical media player reproducing content recorded on the optical recording medium; and
unreadable data writing means for writing unreadable data to the designated area which is ignored by the standard-compliant optical media player,
wherein when an optical medium drive attempts to read the unreadable data in order to perform a one-to-one copy process on data recorded on the recording medium, the optical medium drive is unable to complete the one-to-one copy process.

18. The apparatus of claim 17, wherein said flagging means is included in an authoring tool.

19. The apparatus of claim 17, wherein designation by said flagging means of the area to be ignored signifies that the designated area is free of normal content.

20. The apparatus of claim 17, wherein said flagging means designates the area to be ignored in accordance with user input.

21. The apparatus of claim 17, wherein the area designated by said flagging means to be ignored is predetermined.

22. The apparatus of claim 17, wherein designation by said flagging means of the area to be ignored is compliant with an optical media recording standard.

23. The apparatus of claim 17, wherein said writing means is included in a pre-mastering tool.

24. The apparatus of claim 17, wherein said writing means is included in a mastering tool.

25. An optical recording medium comprising unreadable data written in an area which is designated to be ignored by a standard-compliant optical media player, and wherein when an optical medium drive attempts to read the unreadable data in order to perform a one-to-one copy process on data recorded on the recording medium, the optical medium drive is unable to complete the one-to-one copy process.

26. The optical recording medium of claim 25, wherein the optical recording medium is a DVD disc.

27. An optical recording medium comprising pits having a minimum pit length in a range of 0.4 to 0.44 μm and a pit width which is substantially 0.32 μm, wherein said optical recording medium has unreadable data written in an area which is designated to be ignored by a standard-compliant optical media player, and when an optical medium drive attempts to read the unreadable data in order to perform a one-to-one copy process on data recorded on the recording medium, the optical medium drive is unable to complete the one-to-one copy process.

28. The optical recording medium of claim 27, wherein the optical recording medium is a DVD-ROM disc.

29. An optical recording medium comprising tracks having a track pitch which is substantially 0.74 μm, wherein said optical recording medium has unreadable data written in an area which is designated to be ignored by a standard-compliant optical media player, and when an optical medium drive attempts to read the unreadable data in order to perform a one-to-one copy process on data recorded on the recording medium, the optical medium drive is unable to complete the one-to-one copy process.

30. The optical recording medium of claim 29, wherein the optical recording medium is a DVD-ROM disc.
